(19) United States
(12) Patent Application Publication
(10) Pub. No.: US 2024/0123501 A1
(43) Pub. Date: Apr. 18, 2024

(54) PRINTING A THREE-DIMENSIONAL PART WITH ENHANCED DROP PLACEMENT AND SYSTEM AND METHODS THEREOF

(71) Applicant: XEROX CORPORATION, Norwalk, CT (US)

(72) Inventors: Jason M. LeFevre, Penfield, NY (US); Seemit Praharaj, Webster, NY (US); Douglas K. Herrmann, Webster, NY (US); Varun Sambhy, Pittsford, NY (US)

(73) Assignee: XEROX CORPORATION, NORWALK, CT (US)

(21) Appl. No.: 18/047,359

(22) Filed: Oct. 18, 2022

(51) Int. Cl. B22F 10/22; B22F 10/322; B22F 12/30; B22F 12/50; B22F 12/70; B33Y 10/00; B33Y 30/00

(52) U.S. Cl. CPC B22F 10/22; B22F 10/322; B22F 12/30; B22F 12/50; B22F 12/70; B33Y 10/00; B33Y 30/00; B22F 2201/11; B22F 2301/052

(57) ABSTRACT

A method of forming a three-dimensional printed part is disclosed, including ejecting a drop of print material from an ejector for a printing system in a substantially vertical trajectory, directing a stream of inert gas toward the drop of print material from a first direction, and diverting the drop of print material from the substantially vertical trajectory prior to the drop of print material landing onto a surface. The method includes directing a stream of inert gas toward the drop of print material from other directions. A printing system includes at least a first channel oriented in a first plane parallel to the substrate and positioned between the substrate and the ejector, and a gas supply connected to the first channel.

### TECHNICAL FIELD

The present teachings relate generally to liquid ejectors in drop-on-demand (DOD) printing and, more particularly, to methods and apparatus for controlling drop placement while printing three-dimensional parts within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, 3D printing technology is well known for enabling the manufacture of complex 3D designs which otherwise could not be made using traditional methods such as machining, casting, or injection molding. This ability is made possible through a common trait that all the 3D printing processes share, which is to divide a given geometry along the printing direction into multiple two-dimensional (2D) layers and print one layer at a time. In this approach, complex features, such as re-entrant geometries, hollow features, fine features which the traditional tools cannot machine owing to space constraints or reachability, and the like, are divided among multiple layers and fairly simple 2D layers are printed one above the other until the entire object is completed in this fashion. Despite this straightforward approach, each 3D printing process by virtue of its working principle or construction has its own challenges to tackle. One such common challenge manifests in the form of overhangs. An overhang is an unsupported feature of a 3D printed part that is unsupported by an underlying support structure. A layer-by-layer printing approach can produce one or more undersides of a slope in a part, where each subsequent layer must protrude slightly beyond a preceding layer. As the molten printed material is still in its flowable liquid state prior to solidification, gravity and other factors, such as the angle and slope of the overhang, can result in drooping or sagging, curling, or the prohibition of printing a desired shape altogether. In current 3D printing technology, support structures are created to provide the mechanical support for object surfaces which include overhanging structures not supported by a previously printed layer of build material. The support structure is usually made from the same printing material as the build material. This support material is adhered to the build material in the same manner as the layer-to-layer is bonded in the build portion of the object. Consequently, the support material can be difficult to remove and can leave a very rough surface even after it has been removed. An alternate way of achieving build objects with reduced support structure is to utilize a 4th-axis in a printing system, which can “tilt” the X-Y stage to orient the object so that printing an overhang possible without the use of support material. However, in tilting the X-Y axis stage, a physical interference between the printed part and the printhead & Z-axis stage hardware can occur.

Thus, a method of and apparatus for printing overhangs and other unsupported structures in a drop-on-demand or 3D printer is needed to produce a wider variety of features in 3D printed parts in such a way that the “support material” is not needed while avoiding issues with unsupported structural features.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of forming a three-dimensional printed part is disclosed. The method of forming a three-dimensional printed part also includes ejecting a drop of print material from an ejector for a printing system in a substantially vertical trajectory, directing a stream of inert gas toward the drop of print material from a first direction, and diverting the drop of print material from the substantially vertical trajectory prior to the drop of print material landing onto a surface. Implementations of the method of forming a three-dimensional printed part may include one where the drop of print material does not land onto the surface in a position that is along the substantially vertical trajectory. The method of forming a three-dimensional printed part may include directing a stream of inert gas toward the drop of print material from a second direction. A plane of the first direction and the second direction are perpendicular relative to the substantially vertical trajectory. The method may include directing a stream of inert gas toward the drop of print material from a third direction, and directing a stream of inert gas toward the drop of print material from a fourth direction. The third direction and the fourth direction each reside in a common plane, while the third direction and the fourth direction are oriented 90 degrees from one another, and the third direction is oriented 180 degrees from the first direction. The first direction and the second direction each reside in a common plane and are oriented 90 degrees from one another. The method may include ejecting one or more subsequent drops of print material from the ejector for a printing system in a substantially vertical trajectory, directing a stream of inert gas toward the one or more subsequent drops of print material from the first direction, and diverting the one or more subsequent drops of print material from the substantially vertical trajectory prior to the one or more subsequent drops of print material landing onto a surface. The subsequent drop of print material does not land in a vertical alignment relative to a preceding drop of print material. The surface is a substrate of the printing system. The surface is a top layer of the three-dimensional printed part. The inert gas is argon. The print material may include a metal, a metal alloy, or a combination thereof. The print material may include aluminum.

A method of forming an overhang for a three-dimensional printed part is also disclosed. The method also includes ejecting a first drop of print material from an ejector for a printing system in a substantially vertical trajectory, ejecting one or more subsequent drops of print material from an ejector for a printing system in a substantially vertical trajectory, directing a stream of inert gas toward the one or more subsequent drops of print material from a first direction, diverting the drop of print material from the substantially vertical trajectory prior to the drop of print material landing onto the first drop of print material where the one or more subsequent drops of print material do not land onto the first drop of print material in a position that is along the substantially vertical trajectory. Implementations of the method of forming an overhang for a three-dimensional printed part may include directing a stream of inert gas toward the drop of print material from a second direction, directing a stream of inert gas toward the drop of print material from a third direction, and directing a stream of inert gas toward the drop of print material from a fourth direction. A plane of the first direction and the second direction are perpendicular relative to the substantially vertical trajectory. The first direction and the second direction each reside in a common plane and are oriented 90 degrees from one another. The third direction and the fourth direction each reside in a common plane, the third direction and the fourth direction are oriented 90 degrees from one another, and the third direction is oriented 180 degrees from the first direction.

A printing system is disclosed that includes a substrate and an ejector configured for jetting a print material onto the substrate. The system also includes a first channel oriented in a first plane parallel to the substrate and positioned between the substrate and the ejector, and a gas supply connected to the first channel. Implementations of the printing system may include a second channel connected to the gas supply, where a longitudinal axis of the first channel and the longitudinal axis of the second channel each reside in a common plane and are oriented 90 degrees from one another. A longitudinal axis of the third channel and a longitudinal axis of the fourth channel each reside in the same common plane as the longitudinal axis of the first channel and the longitudinal axis of the second channel. The longitudinal axis of the third channel and the longitudinal axis of the fourth channel are oriented 90 degrees from one another, and the longitudinal axis of the third channel is oriented 180 degrees from the longitudinal axis of the first channel. The gas supply is configured to deliver an inert gas to the first channel, the second channel, the third channel, the fourth channel, or a combination thereof. The print material may include a metal, a metal alloy, or a combination thereof. The print material may include aluminum.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIGS. 2A-2B depict a side view of a portion of a 3D printer, showing an alternate method and system for building a 3D object without support structures, in accordance with the present disclosure.

FIGS. 3A-3C depict a side view of a portion of a 3D printer, an enlarged side view of a portion of a 3D printer, and a top view cross-section of a portion of a 3D printer showing a method and system for building a 3D object without support structures, in accordance with the present disclosure.

FIG. 4 is a plot estimating drop placement angle as a function of inert gas cross-stream velocity in a 3D printer utilizing a method and system for building a 3D object without support structures, in accordance with the present disclosure.

FIG. 5 is a flowchart illustrating a method of forming a three-dimensional printed part without support structures, in accordance with the present disclosure.

FIG. 6 is a flowchart illustrating a method of forming a three-dimensional printed part without support structures, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary examples of the present teachings, examples of which are illustrated in the accompanying drawings. Wherever possible, the same reference numbers will be used throughout the drawings to refer to the same, similar, or like parts.

Examples of the present teachings provide a system and method for printing an overhang or extended portion for a three-dimensional build object that includes no support structure between an overhang of the part and a print bed or substrate. Certain liquid metal printing processes do not make use of a metal powder bed to form its aluminum or other metal parts, and as such, printing extreme overhangs can in some circumstances are only be possible by bridging over support structures. Currently, support structure layers are made of finely spaced extended, solid supports constructed of aluminum or other applicable print material. Once the part has completed printing, these support structures must be removed, which can often leave a rough overhanging side due to molten metal or molten print material sinking between the fine gaps of the support structures prior to solidification and some remnant support structures can still be left attached to the part after support removal. This involves one or more secondary operations post-printing to provide a better surface finish.

As it is desirable to utilize a system able to print overhangs in such a way that the support material is not needed, examples of the present disclosure provide a printing approach and system that enables the printing of three-dimensional parts or components with overhangs by using directed streams of inert gas, such as argon or carbon dioxide, to alter the flight path of one or more ejected drops so that an angle of the drop path when it contacts the part is substantially deviated from a standard perpendicular flight path. The resultant change in the angle of incidence of the drop relative to the build part can allow the one or more drops to adhere to the three-dimensional build part or 3D object in a manner that is beneficial to printing instances where the drop is being placed on an overhang type feature. This approach will avoid a requirement for a 4th-axis in a printing system. Since overhanging features on the build object can be in any direction in the X-Y plane, it is desirable to have directed stream of gas in the X-axis, as well as a directed stream of gas in the Y-axis.

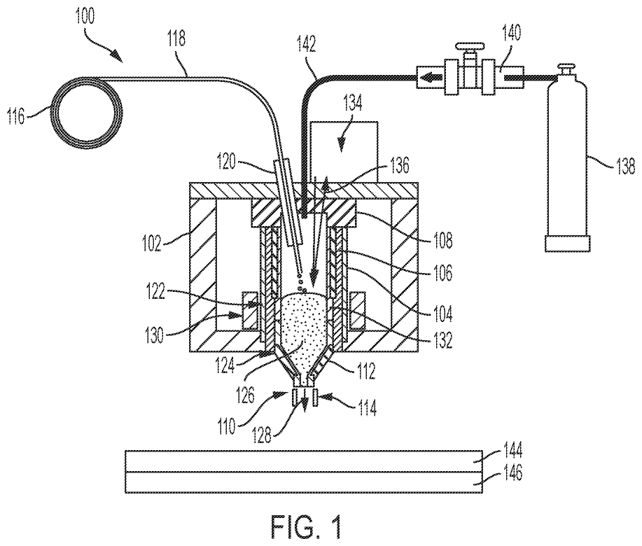

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 can be defined as an inner volume 132 (also referred to as an internal cavity or an inner cavity). The ejector 104 can be defined as a structure that can be selectively activated in such a manner as to cause a build material, print material to be ejected from a nozzle 110 of the ejector. The nozzle 110 can be defined as a physical structure of the ejector from which a build material or print material takes flight. A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, that is positioned proximate to (e.g., below) the nozzle 110. The substrate 144 may include a heating element, or alternatively be constructed of brass or other materials. In certain examples, the substrate 144 may further include a build plate made of brass which can be coated with nickel to promote the wetting of molten aluminum droplets when they impinge on the build plate. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Z direction. In case of a nozzle 110 moving, the nozzle 110 and other printhead assembly components can include a nozzle or printhead motor control, not shown herein.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein may alternatively include other printing materials such as plastics or other ductile materials that are non-metals. The print material may include a metal, a metallic alloy, or a combination thereof. A non-limiting example of a printing material may include aluminum. Exemplary examples of printing systems of the present disclosure may include an ejector for jetting a print material, including a structure defining an inner cavity, and a nozzle orifice in connection with the inner cavity and configured to eject one or more droplets of liquid print material, wherein the ejector is configured to print a first layer of a three-dimensional printed part from a standoff position relative to the substrate 144 and the ejector is configured to print one or more remaining layers onto the first layer from a z-height position relative to a top surface of the first layer. In certain examples of the liquid ejector jet system 100, a stabilizing base 146 is present below the substrate 144, providing stability to the structure. Exemplary materials for such a stabilizing base 146 can include granite or other high density, inert materials.

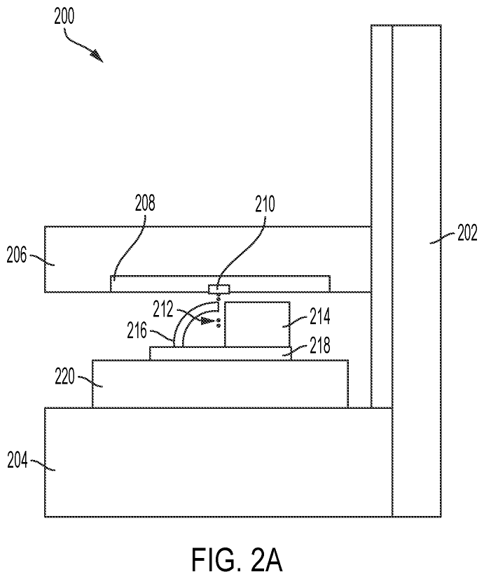

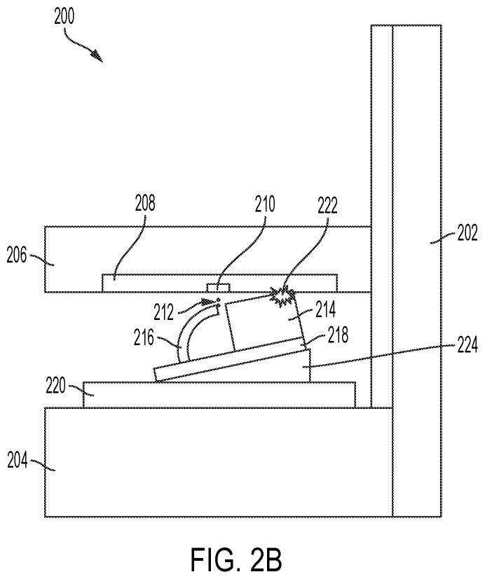

FIGS. 2A-2B depict a side view of a portion of a 3D printer, showing an alternate method and system for building a 3D object without support structures, in accordance with the present disclosure. In some part geometries, there may be the need to print on an overhanging surface or an overhang structure. This is a portion of a build or support where the build part has structures which do not have material immediately below current layer being printed. In some situations, this overhang surface is printed without a support structure. However, printing in this manner can present difficulties because of the extreme accuracy needed for drop placement. If, for example, a drop on a particular layer misses its target, it will not land on the part and becomes lost, making it very likely that the subsequent drops in that area will also miss their target. This results in poor part dimensional quality. An example of this situation is shown in FIG. 2A. In a 3D printer 200 as shown in FIG. 2A, a z-axis 202 is attached to a granite base 204 and holds a printhead area 206, containing a thermal shield 208 and a nozzle 210. The nozzle ejects a plurality of drops 212, to form a build part or 3D printed object 214, including an overhang 216 portion of the 3D printed object 214. The 3D printed object 214 is printed onto a build plate or substrate 218 which is held upon and translates with an x/y stage 220 that is upon the granite base 204. In very steep overhanging surfaces, a support structure is sometimes created to provide the mechanical support for object surfaces which are not supported by a previous layer of build material. The support structure is made from the same aluminum alloy as the build material. This support material is adhered to the build material in the same manner as the layer-to-layer is bonded in the build portion of the object. Consequently, the support material can be difficult to remove and can leave a rough surface after it has been removed.

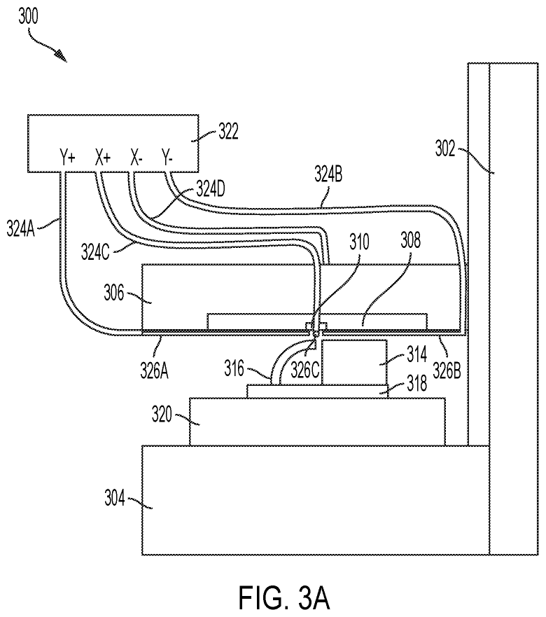

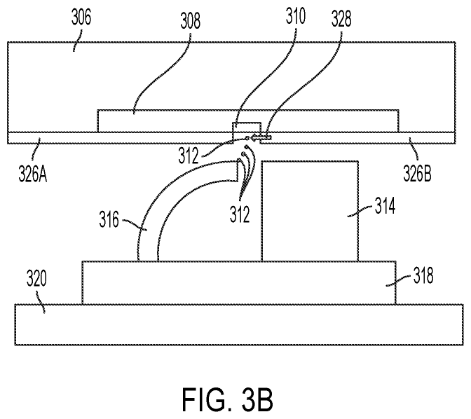

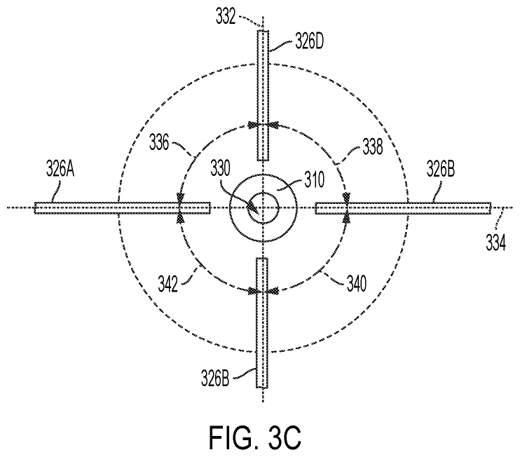

One known method for printing on overhanging surfaces is to add a 4^{th}-axis 224 to the 3D printer 200, which can tilt the substrate 218 on the X-Y stage 220 to orient the object 214 so that printing an overhang 216 is possible without the use of support material. Unfortunately, when tilting the X-Y axis stage 220 with the 4^{th}-axis 224, this can lead to a physical interference 222 between the printed part 214 and the printhead 208 and possibly the Z-axis stage hardware 202. In certain 3D printer 200 systems, the gap between the printhead 208 and the object 214 is approximately 5-7 mm, and with the use of a build plate or substrate 218 of either 150 mm by 150 mm, a small build plate, or a 300 mm by 300 mm, large build plate, it is shown, as depicted in FIG. 3B, how a small angle on the 4^{th}-axis 224 can result in a physical interference 222 of the build plate or substrate 218 and the Z-axis hardware 202 and the printhead 208.

FIGS. 3A-3C depict a side view of a portion of a 3D printer, an enlarged side view of a portion of a 3D printer, and a top view cross-section of a portion of a 3D printer showing a method and system for building a 3D object without support structures, in accordance with the present disclosure. A 3D printer 300 having a Z-axis stage hardware 302, attached to a granite base 304 and holding a printhead area 306, containing a thermal shield 308 and a nozzle 310 is shown. The nozzle ejects a plurality of drops 312, to form a build part or 3D printed object 314, including an overhang 316 portion of the 3D printed object 314. The 3D printed object 314 is printed onto a build plate or substrate 318 which is held upon and translates with an x/y stage 320 that is upon the granite base 304. Also located in the 3D printer 300 system is an inert gas supply 322, which includes a manifold that supplies an inert gas to four gas supply lines, including a Y+ direction gas supply line 324A, a Y− direction gas supply line 324B, an X+ direction gas supply line 324C, and an X− direction gas supply line 324D. These four gas supply lines provide inert gas, respectively, to each of four channels or tubes, a Y+ direction channel 326A, a Y− direction channel 326B, an X+ direction channel 326C, and an X− direction channel 326D. These four channels, 326A, 326B, 326C, 326D are all directed towards a location below the nozzle 310 and focused on a position between where a plurality of drops 312 are ejected from the nozzle 310 and where one or more of a plurality of drops 312 may land. As the gap between the printhead nozzle and the build surface is typically maintained, most commonly between 5 mm and 7 mm, the tubes or channels must fit within this space. Tube sizes can be up to within some maximum diameter that is equal to the gap minus some safety clearance to ensure that there is no incidental interference between the tubes or channels and the part itself. Tubing wall thickness can be sized appropriately, and do not need to be thick unless that is helpful for reducing distortion due to the heated nature of the location of tube or channel entry into the system enclosure. In certain examples, the tube material can be made of stainless-steel, ceramic, or any other material suited for high temperature applications. As described herein, the term “channel” shall be defined as a physical structure defining a channel.

This 3D printing system 300 provides the use of directed streams of inert gas, for example, argon, CO₂, helium, and the like, to alter the flight path of the ejected drop 312 so that the angle of the drop path when it contacts the part is substantially deviated from the standard perpendicular flight path. The change in the angle of incidence of the drop relative to the build part 314 will be such that it allows the drop 312 to adhere to the build part in a manner that is beneficial to printing instances where the drop 312 is being placed on an overhang 316 type feature. Such an approach can produce the same effect as adding a 4^{th}-axis, without the restraint shown in FIG. 2B of having to ensure that the build part 314 does not mechanically interfere with the print head or Z-axis hardware 302. Overhanging features on the build object 314 can be in any direction in the X-Y plane, as shown in FIG. 3C, therefore, it can be useful to have directed stream of gas in an X-axis 334, as well as a directed stream of gas in a Y-axis 332. The combination of the force placed on the drop 312 in the X-axis 334 as well as the Y-axis 332 will result in a change in the drop trajectory that is beneficial for the construction of the overhanging feature 316.

As showing in FIG. 3B and in FIG. 3C, small metal tubes or channels 326A, 326B, 326C, 326D will supply the directed gas stream and can be placed in a position that is just below the surface of the existing heat shield 308. The tubes 326A, 326B, 326C, 326D will be small enough to fit in a nominal 5-7 mm print head gap to the build part. The tubes 326A, 326B, 326C, 326D are shown positioned around the nozzle, which is shown as having a nozzle orifice 330. The four channels or tubes, the Y+ direction channel 326A, the Y− direction channel 326B, the X+ direction channel 326C, and the X− direction channel 326D include two tubes for each axis, two for the X− axis 334 and two for the Y-axis 332 with each axis having a tube in the positive and negative direction. The type of gas used for the directed stream will be inert, so that additional surface oxidation of the drop does not become an issue. The drops 312 shown in FIG. 3B shows how a change 328 in the angle of incidence of the drop 312 relative to the build part can be influenced such that it allows the drops 312 to adhere to the build part 314 in a manner that is beneficial to printing instances where the drop 312 is being placed on an overhang type feature 316. In FIG. 3B, the drop trajectory 328 is only being altered in one axis, however it is appreciated that, as described previously, the gas streams can change the drop flight path in any direction in the X/Y space. An angle 336 between the Y+ direction channel 326A and the X− direction channel 326D is shown as approximately 90 degrees, as is the angle 338 between the X− direction channel 326D and the Y− direction channel 326B, the angle 340 between the Y− direction channel 326B, and the X+ direction channel 326C, and the angle 342 between the X+ direction channel 326C and the Y+ direction channel 326A. While this positional arrangement and number of tubes or channels is shown, alternate examples may have as few as one, and as many as six to eight tubes in a system, where angles may range from any angle from about 10 degrees to about 180 degrees between each tube or channel.

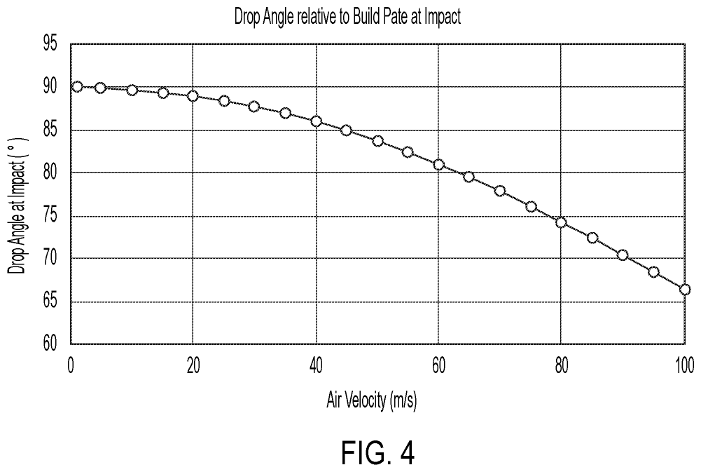

FIG. 4 is a plot estimating drop placement angle as a function of inert gas cross-stream velocity in a 3D printer utilizing a method and system for building a 3D object without support structures, in accordance with the present disclosure. The plot shown in FIG. 4 outlines a basic kinematic estimate of the drop displacement and the resulting incident angle of the drop relative to the build surface as a function of the gas tube flow velocity. The resulting angle plotted on a range of 1 m/s to 100 m/s air velocity, which shows that even at a gas velocity of 60 m/s the resulting angle is 80°, which is a 10° deviation from the drop angle with no gas crossflow present. At 100 m/s the resulting angle is very significant at 66°, approximately a 24° deviation from perpendicular. This 50 m/s to 100 m/s range of gas flow is a useful target for the gas tube flow, or from 10 m/s to about 300 m/s or from about 25 m/s to about 100 m/s, or from about 50 m/s to about 100 m/s. Example input parameters and results are shown below in Table 1.

TABLE 1
Input Parameters

| | units | | | | | | |
|---|---|---|---|---|---|---|---|
| | kg/m3 | m/s | m/s | m | | kg/m3 | m |
| Drag coefficient | Air | Drop | Air | Drop | m | density of | drop |
| of a sphere | Density | Velocity | Velocity | Radius | gap | aluminum | radius |
| 0.47 | 1.2 | 5 | 100 | 0.00025 | 0.007 | 2700 | 0.00025 |

X/Y Plane
units

| | | | | |
|---|---|---|---|---|
| kg | N | m/s2 | m | μm |

| | | | |
|---|---|---|---|
| Drop Mass | Force on drop | Acceleration of drop | Displacement of drop |

| | | | | |
|---|---|---|---|---|
| 1.77E−07 | 0.000553706 | 3133.33 | 0.003070667 | 3070.666667 |

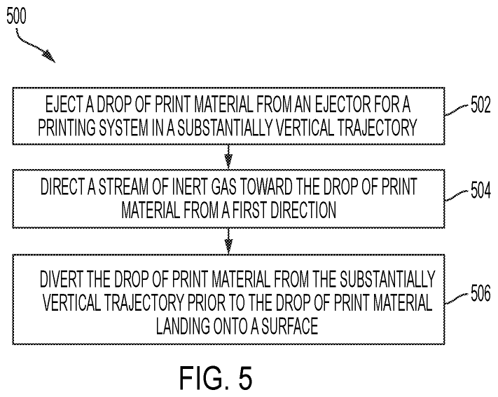

FIG. 5 is a flowchart illustrating a method of forming a three-dimensional printed part without support structures, in accordance with the present disclosure. A method of forming a three-dimensional printed part 500, includes the steps of ejecting a drop of print material from an ejector for a printing system in a substantially vertical trajectory 502, directing a stream of inert gas toward the drop of print material from a first direction 504, and diverting the drop of print material from the substantially vertical trajectory prior to the drop of print material landing onto a surface 506. The method of forming a three-dimensional printed part 500 may include where a drop of print material does not land onto the surface in a position that is along the substantially vertical trajectory. The method of forming a three-dimensional printed part 500 may include directing a stream of inert gas toward the drop of print material from a second direction, where a plane of the first direction and the second direction are perpendicular relative to the substantially vertical trajectory. Alternatively, the method of forming a three-dimensional printed part 500 may include directing a stream of inert gas toward the drop of print material from a third direction, and directing a stream of inert gas toward the drop of print material from a fourth direction. In other examples, the first direction and the second direction each reside in a common plane and are oriented 90 degrees from one another. Other examples of the method of forming a three-dimensional printed part 500 include where the third direction and the fourth direction each reside in a common plane, the third direction and the fourth direction are oriented 90 degrees from one another, and the third direction is oriented 180 degrees from the first direction. The method of forming a three-dimensional printed part 500 may further include a step of ejecting one or more subsequent drops of print material from the ejector for a printing system in a substantially vertical trajectory, directing a stream of inert gas toward the one or more subsequent drops of print material from the first direction, and diverting the one or more subsequent drops of print material from the substantially vertical trajectory prior to the one or more subsequent drops of print material landing onto a surface. The subsequent drop or drops of print material does not land in a vertical alignment relative to a preceding drop of print material in this and other examples. The surface in question can be a substrate of the printing system, a top layer of the three-dimensional printed part, or a combination thereof. In some examples, the inert gas is argon, or carbon dioxide, helium, and the like. The printing material, build material, or the material the one or more drops are composed of can include a metal, such as aluminum, a metal alloy, or a combination thereof.

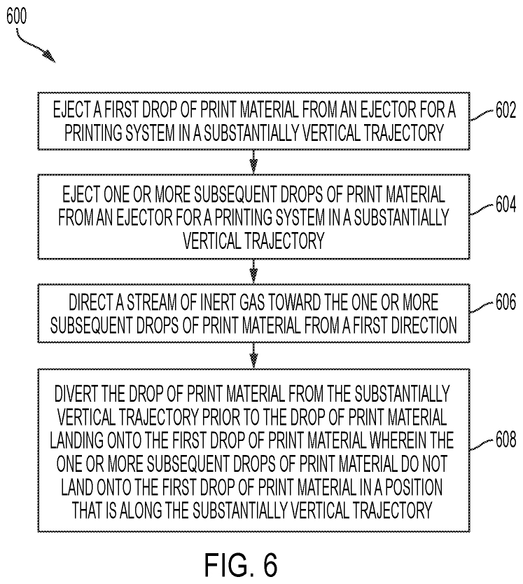

FIG. 6 is a flowchart illustrating a method of forming a three-dimensional printed part without support structures, in accordance with the present disclosure. A method of forming an overhang for a three-dimensional printed part 600 includes a step of ejecting a first drop of print material from an ejector for a printing system in a substantially vertical trajectory 602 and ejecting one or more subsequent drops of print material from an ejector for a printing system in a substantially vertical trajectory 604. Next, a stream of inert gas is directed toward the one or more subsequent drops of print material from a first direction 606 and this serves to divert the drop of print material from the substantially vertical trajectory prior to the drop of print material landing onto the first drop of print material wherein the one or more subsequent drops of print material do not land onto the first drop of print material in a position that is along the substantially vertical trajectory 608. In certain examples of the method of forming an overhang for a three-dimensional printed part 600 also includes directing a stream of inert gas toward the drop of print material from a second direction, directing a stream of inert gas toward the drop of print material from a third direction, and directing a stream of inert gas toward the drop of print material from a fourth direction. The method of forming an overhang for a three-dimensional printed part 600 may include where a plane of the first direction and the second direction are perpendicular relative to the substantially vertical trajectory, or the first direction and the second direction each reside in a common plane and are oriented 90 degrees from one another, or a combination thereof. In exemplary examples of the method of forming an overhang for a three-dimensional printed part 600, the third direction and the fourth direction each reside in a common plane, the third direction and the fourth direction are oriented 90 degrees from one another, and the third direction is oriented 180 degrees from the first direction.

Methods and systems as disclosed herein provide directed streams of an inert gas to alter the flight path of an ejected drop so that the angle of the drop path when it contacts a part or substrate can be substantially deviated from the standard perpendicular (90°) flight path. The means for changing the angle of incidence of the drop relative to the build part can provide a capability for a drop to adhere to a build part in a manner that is beneficial to printing instances where the drop is being placed on an overhang type feature. Such directed streams of gas in the X-axis, as well as in the Y-axis provide a combination of the force placed on the droplet in the X-axis as well as the Y-axis resulting in a change in the drop trajectory that is beneficial for the construction of the overhanging feature. Small channels or metal tubes can supply the directed gas stream and can be placed in a position that is just below the surface of an existing heat shield of a 3D printing system. The tubes can be small enough to fit in the nominal 5-7 mm print head gap to the build part. Methods and systems as disclosed herein can serve to eliminate or greatly reduce the need for support material, which can be difficult to remove and leave a rough surface once it has been removed. Furthermore, this system avoids a need for a 4th-axis to the machine, which can lead to a physical interference between the printed part and the printhead & Z-axis stage hardware and increase system cost and complexity. This system can allow for a broader range of geometries for printing metal parts, similar to those made in a casting process.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of forming a three-dimensional printed part, comprising:
ejecting a drop of print material from an ejector for a printing system in a substantially vertical trajectory;
directing a stream of inert gas toward the drop of print material from a first direction; and
diverting the drop of print material from the substantially vertical trajectory prior to the drop of print material landing onto a surface.

2. The method of claim 1, wherein the drop of print material does not land onto the surface in a position that is along the substantially vertical trajectory.

3. The method of claim 1, further comprising directing a stream of inert gas toward the drop of print material from a second direction.

4. The method of claim 3, wherein a plane of the first direction and the second direction are perpendicular relative to the substantially vertical trajectory.

5. The method of claim 4, further comprising:
directing a stream of inert gas toward the drop of print material from a third direction; and
directing a stream of inert gas toward the drop of print material from a fourth direction.

6. The method of claim 3, wherein the first direction and the second direction each reside in a common plane and are oriented 90 degrees from one another.

7. The method of claim 5, wherein:
the third direction and the fourth direction each reside in a common plane;
the third direction and the fourth direction are oriented 90 degrees from one another; and
the third direction is oriented 180 degrees from the first direction.

8. The method of claim 1, further comprising:
ejecting one or more subsequent drops of print material from the ejector for a printing system in a substantially vertical trajectory;
directing a stream of inert gas toward the one or more subsequent drops of print material from the first direction; and
diverting the one or more subsequent drops of print material from the substantially vertical trajectory prior to the one or more subsequent drops of print material landing onto a surface.

9. The method of claim 8, wherein the subsequent drop of print material does not land in a vertical alignment relative to a preceding drop of print material.

10. The method of claim 1, wherein the surface is a substrate of the printing system.

11. The method of claim 1, wherein the surface is a top layer of the three-dimensional printed part.

12. The method of claim 1, wherein the inert gas is argon.

13. The method of claim 1, wherein the print material comprises a metal, a metal alloy, or a combination thereof.

14. The method of claim 1, wherein the print material comprises aluminum.

15. A method of forming an overhang for a three-dimensional printed part, comprising:
ejecting a first drop of print material from an ejector for a printing system in a substantially vertical trajectory;
ejecting one or more subsequent drops of print material from an ejector for a printing system in a substantially vertical trajectory;
directing a stream of inert gas toward the one or more subsequent drops of print material from a first direction; and
diverting the drop of print material from the substantially vertical trajectory prior to the drop of print material landing onto the first drop of print material wherein the one or more subsequent drops of print material do not land onto the first drop of print material in a position that is along the substantially vertical trajectory.

16. The method of claim 15, further comprising:
directing a stream of inert gas toward the drop of print material from a second direction;
directing a stream of inert gas toward the drop of print material from a third direction; and
directing a stream of inert gas toward the drop of print material from a fourth direction.

17. The method of claim 16, wherein a plane of the first direction and the second direction are perpendicular relative to the substantially vertical trajectory.

18. The method of claim 16, wherein the first direction and the second direction each reside in a common plane and are oriented 90 degrees from one another.

19. The method of claim 18, wherein:
the third direction and the fourth direction each reside in a common plane;
the third direction and the fourth direction are oriented 90 degrees from one another; and
the third direction is oriented 180 degrees from the first direction.

20. A printing system comprising:
a substrate;
an ejector configured for jetting a print material onto the substrate;
a first channel oriented in a first plane parallel to the substrate and positioned between the substrate and the ejector; and
a gas supply connected to the first channel.

21. The printing system of claim 20, further comprising a second channel connected to the gas supply, wherein a longitudinal axis of the first channel and the longitudinal axis of the second channel each reside in a common plane and are oriented 90 degrees from one another.

22. The printing system of claim 21, further comprising:
a third channel connected to the gas supply; and
a fourth channel connected to the gas supply, wherein a longitudinal axis of the third channel and a longitudinal axis of the fourth channel each reside in the same common plane as the longitudinal axis of the first channel and the longitudinal axis of the second channel.

23. The printing system of claim 22, wherein:
the longitudinal axis of the third channel and the longitudinal axis of the fourth channel are oriented 90 degrees from one another; and
the longitudinal axis of the third channel is oriented 180 degrees from the longitudinal axis of the first channel.

24. The printing system of claim 22, wherein the gas supply is configured to deliver an inert gas to the first channel, the second channel, the third channel, the fourth channel, or a combination thereof.

25. The printing system of claim 22, wherein the print material comprises a metal, a metal alloy, or a combination thereof.

26. The printing system of claim 22, wherein the print material comprises aluminum.
